(19) United States
(12) Patent Application Publication
(10) Pub. No.: US 2015/0176717 A1
(43) Pub. Date: Jun. 25, 2015

(54) INLET VALVE EXPLOSION-PROOF STRUCTURE

(71) Applicants: WATER BOGER BIOCHEMICAL TECHNOLOGY CO., LTD., Changhua County (TW); Water Boger Hardware (Shenzhen) Co., Ltd., Shenzhen City (CN)

(72) Inventor: Po An TENG, Changhua County (TW)

(73) Assignees: WATER BOGER BIOCHEMICAL TECHNOLOGY CO., LTD., Changhua County (TW); Water Boger Hardware (Shenzhen) Co., Ltd., Shenzhen City (CN)

(21) Appl. No.: 14/157,367

(22) Filed: Jan. 16, 2014

(30) Foreign Application Priority Data
Dec. 25, 2013 (TW) 102224420

(51) Int. Cl. F16K 27/04; F16K 15/06

(52) U.S. Cl. CPC F16K 27/04; F16K 15/06

(57) ABSTRACT

An inlet valve explosion-proof structure is provided, and its flow speed of inflow water exceeds in setting values. The force receiving arm of the guide disc body is pressed to closely attach the guide cone portion at the lower side to the edge of the inner ring base portion of the tube combination base body, so that the pilot hole portion of the tube combination base body is sheltered by the guide cone portion to prevent water pipes from exploding due to excessive water pressure or ageing water pipes. Alternatively, it can prevent water faucets from causing water leakage to achieve efficacies of better stable structure and ensuring high usage safety.

The current application claims a foreign priority to the patent application of Taiwan No. 102224420 filed on Dec. 25, 2013.

### BACKGROUND OF THE INVENTION

1. Field of the Invention

The invention relates to an inlet valve explosion-proof structure, and more particularly to a technical field applied to a tail inlet control structure.

2. Description of the Related Art

Conventional sanitary pipe structures are disposed with relief valves (mechanical type or electronic type) between stories of high buildings to supply and distribute water to each story of the high building, but there still exists the following problems:

1. Worse structure stability: the sanitary pipes may break or water faucets may leak due to malfunctioning relief valves among the stories, or failed electric control. The sanitary pipes and the water faucets that are unable to resist the high pressure water lead to worse structure stability.

2. Worse usage safety: the sanitary pipes may break or the water faucets may leak due to malfunctioning relief valves among stories, or failed electric control. The sanitary pipes and the water faucets that are unable to resist the high pressure water lead to loss of usage and the waste of water resources, thereby affecting usage safety.

### SUMMARY OF THE INVENTION

Therefore, upon the foregoing problems of worse stability in conventional sanitary pipes and high usage costs, it is an objective of the present invention to provide an inlet valve explosion-proof structure.

To achieve the foregoing objective, the inlet valve explosion-proof structure comprises of a stationary top ring body, a guide disc body, and a tube combination base body. A water inlet portion is disposed inside the stationary top ring body. An engagement flange portion is disposed to a top side edge of the stationary top ring body, and a guide cone portion is respectively disposed at a lower side and an upper side of the guide disc body. Several force receiving arms are outwardly extended from the bottom side of the guide cone portion. In addition, an inner ring base portion is disposed inside the tube combination base body. A pilot hole portion is disposed inside the inner ring base portion. A propping flange portion is disposed at the external top of the tube combination base body, wherein its guide disc body is contained in the tube combination base body. The several force receiving arms of the guide disc body lean against the inner ring base portion. The stationary top ring body is fitted to the top side of the tube combination base body. The engagement flange portion of the stationary top ring body is engaged to the propping flange portion, disposed to the tube combination base body to form an interval between the several force receiving arms of the guide disc body and the bottom side of the stationary top ring body. Water is introduced by the water inlet portion of the stationary top ring body into the tube combination base body so that the guide disc body disposed inside the tube combination base body is at floating state. An interval is formed between the guide disc body at the floating state and the inner ring base portion of the tube combination base body. Water then is introduced in and out of the pilot hole portion of the tube combination base body. When the flow speed of inflow water exceeds in setting values, the several force receiving arms of the guide disc body is pressed to closely attach the guide cone portion at the lower side on the edge of the inner ring base portion of the tube combination base body, so that the pilot hole portion of the tube combination base body is sheltered by the guide cone portion to achieve a purpose of automatic turning-off. When water pressure reaches the setting value to explode the valve leading to water leakage, the water resource is automatically turned off in no time, preventing the water pipes from exploding due to excessive water pressure or ageing water pipes. Alternatively, it can prevent water faucets from causing water leakage and can be widely applied in large water pipes and oil pipes to prevent water or oil from being wasted when pipes are broken. Moreover, the loss of usage and waste of water resources can be reduced as well to achieve efficacy of more stable structure and ensuring the usage safety.

### BRIEF DESCRIPTION OF THE DRAWINGS

The detailed structure, operating principle and effects of the present invention will now be described in more details hereinafter with reference to the accompanying drawings that show various embodiments of the invention as follows.

FIG. 1 is a three-dimensional assembly state drawing according to the invention;

FIG. 2 is a three-dimensional decomposition state drawing according to the invention;

FIG. 3 is a side view cross-sectional drawing according to the invention;

FIG. 4 is a rotary cross-sectional drawing according to the invention;

FIG. 5 is a floating motion state drawing of the guide disc body according to the invention.

### DETAILED DESCRIPTION OF THE PREFERRED EMBODIMENTS

The technical content of the present invention will become apparent by the detailed description of the following embodiments and the illustration of related drawings as follows.

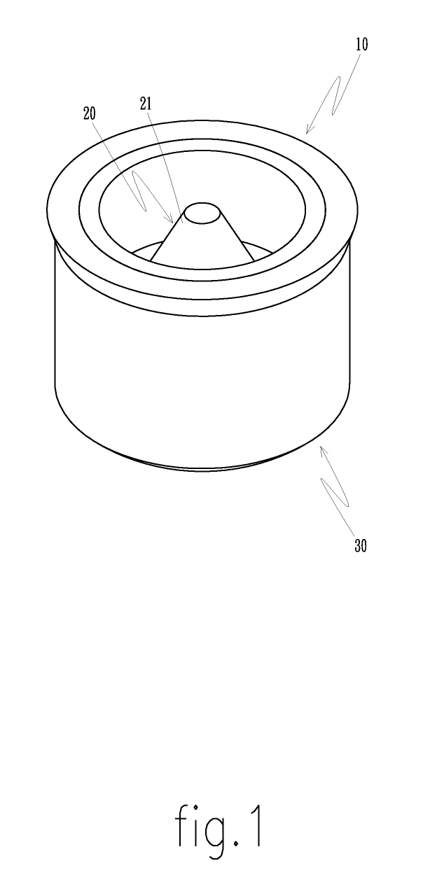

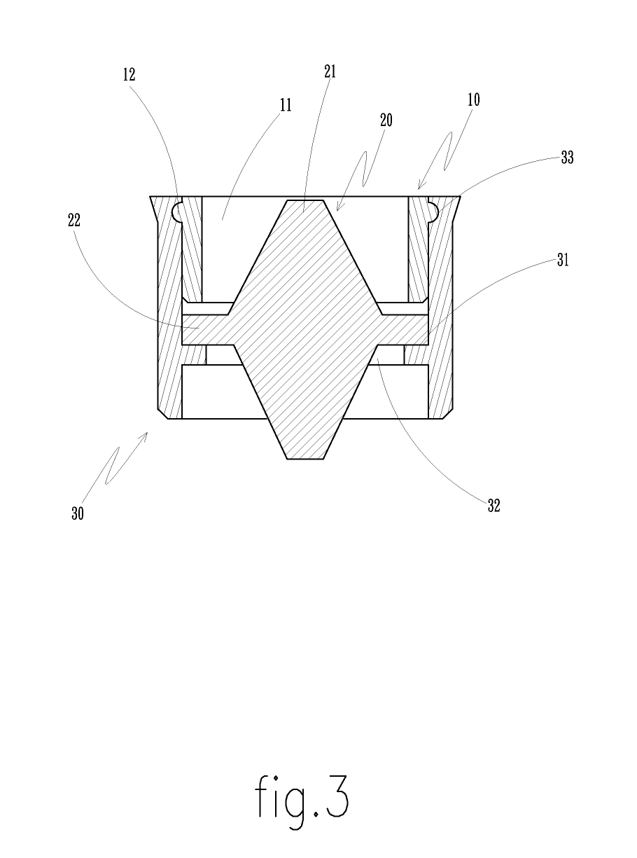

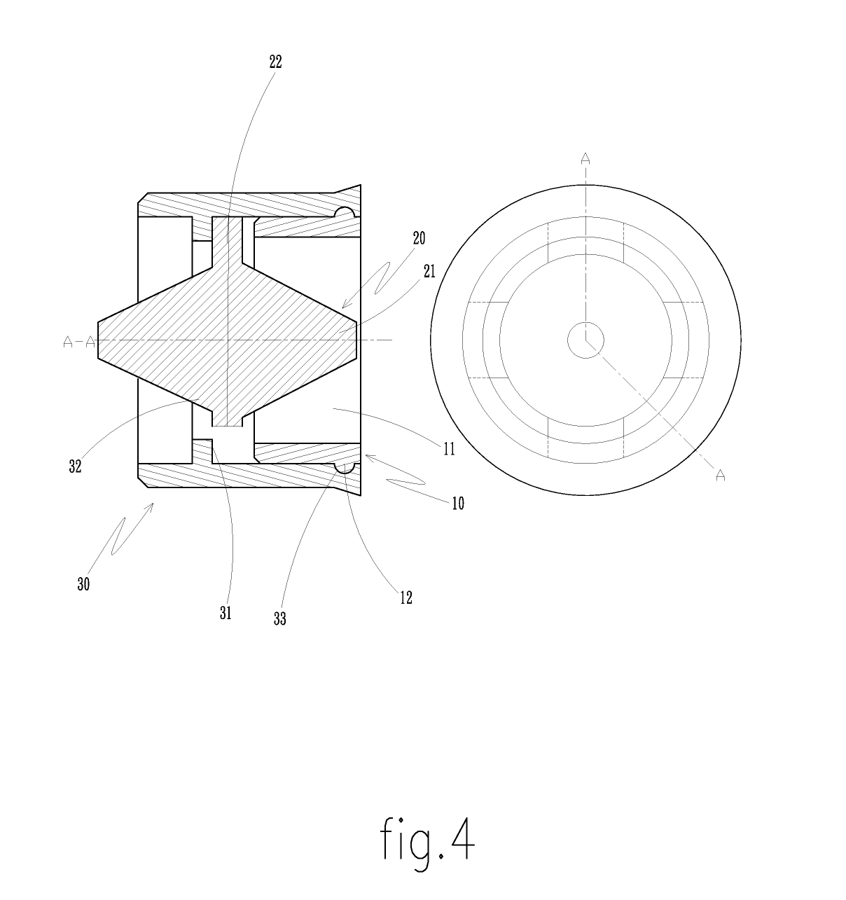

With reference to FIG. 1 to FIG. 4 for a three-dimensional assembly drawing, a three-dimensional decomposition drawing, a side view cross-sectional drawing and a rotary cross-sectional drawing of an inlet valve explosion-proof structure according to the invention are depicted. The structure includes: a stationary top ring body 10, a guide disc body 20, and a tube combination base body 30.

A water inlet portion 11 is disposed at an inside of the stationary top ring body 10. An engagement flange portion 12 is disposed at a top side edge of the stationary top ring body 10.

A guide cone portion 21 is respectively disposed at an upper side and a lower side of the guide disc body 20. Several force receiving arms 22 are outwardly extended from the bottom of the guide cone portion 21. The force receiving arm 22 is relatively disposed at the cross shape.

An inner ring base portion 31 is disposed at an inside of the tube combination base body 30. A pilot hole portion 32 is disposed inside the inner ring base portion 31. A propping flange portion 33 is disposed at an external upper place of the tube combination base body 30. The several force receiving arms 22 of the guide disc body 20 lean against the inner ring base portion 31. The stationary top ring body 10 is fit at the top side of the tube combination base body 30. The engagement flange portion 12 of the stationary top ring body 10 is engaged to the propping flange portion 33 of the tube combination base body 30 to form an interval between the several force receiving arms 22 of the guide disc body 20 and the bottom side of the stationary top ring body 10.

With the foregoing structures, the inlet valve explosion-proof structure according to the invention is completed.

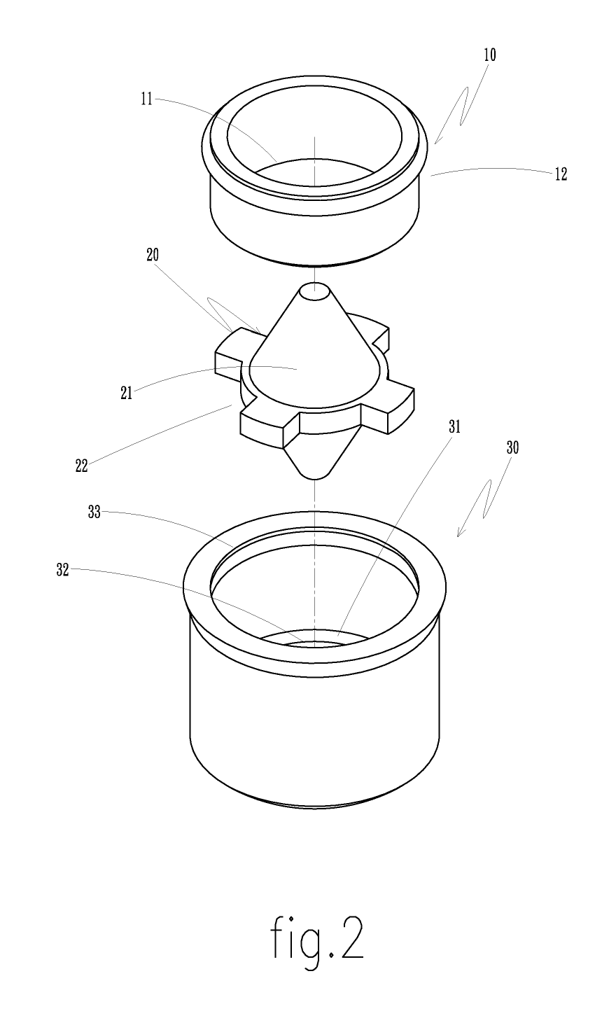

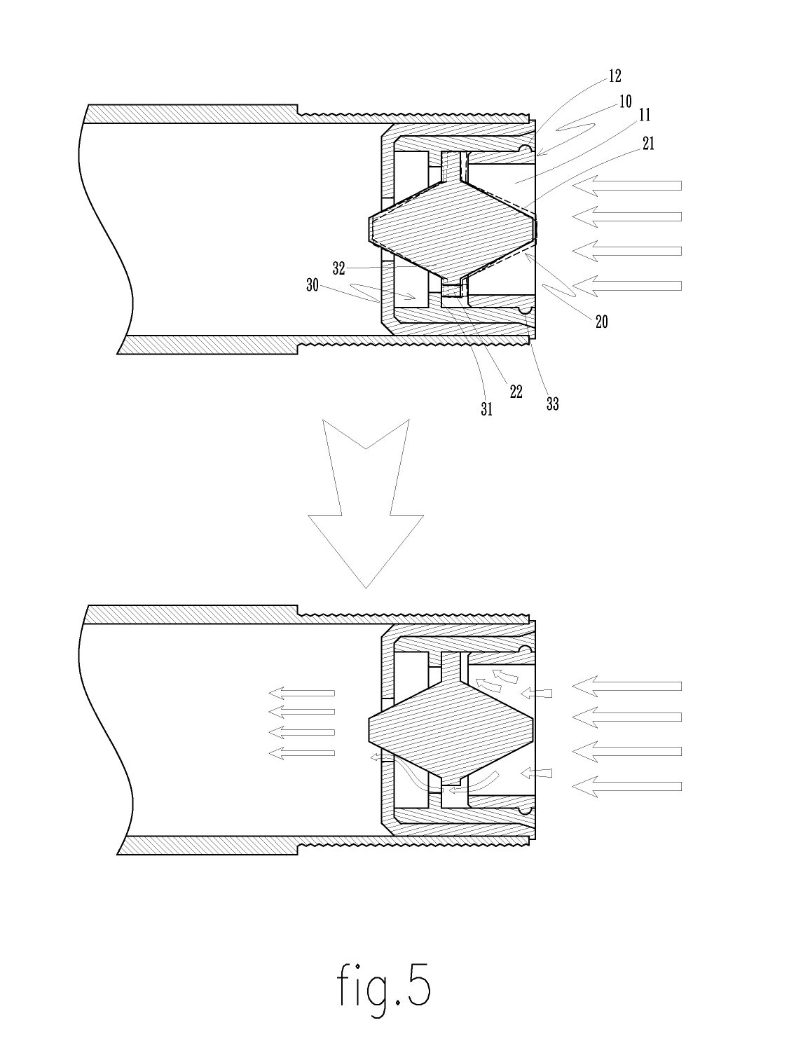

With reference to FIG. 2 to FIG. 5 for a three-dimensional decomposition drawing, a side view cross-sectional drawing, a rotary cross-sectional drawing and a floating motion state drawing of the guide disc body of the inlet valve explosion-proof structure according to the invention are depicted. Its guide disc body 20 is contained in the tube combination base body 30, and the several force receiving arms 22 of the guide disc body 20 lean against the inner ring base portion 31, and the stationary top ring body 10 is fit to the top side of the tube combination base body 30. The engagement flange portion 12 of the stationary top ring body 10 is engaged to the propping flange portion 33 of the tube combination base body 30 to form an interval between the several force receiving arms 22 of the guide disc body 20 and the bottom side of the stationary top ring body 10. Water is introduced by the water inlet portion 11 of the stationary top ring body 10 into the tube combination base body 30 so that the guide disc body 20 disposed inside the tube combination base body 30 is at floating state. An interval is formed between the guide disc body 20 at the floating state and the inner ring base portion 31 of the tube combination base body 30. Water then is introduced in and out of the pilot hole portion 32 of the tube combination base body 30.

When the flow speed of inflow water exceeds in setting values, the force receiving arms 22 of the guide disc body 20 is pressed to allow the guide cone portion 21 at the lower side to closely attach an edge of the inner ring base portion 31 of the tube combination base body 30 so that the pilot hole portion 32 of the tube combination base body 30 is shielded by the guide cone portion 21 to achieve a purpose of automatic turning-off. When water pressure reaches the setting value to explode the valve leading to water leakage, the water resource is automatically turned off in no time, preventing the water pipe from exploding due to excessive water pressure or ageing water pipes. Alternatively, it can be widely applied in large water pipes and oil pipes to prevent water or oil from being wasted when pipes are broken. Moreover, the loss of usage and waste of water resources can be reduced as well to achieve efficacy of more stable structure and ensuring the usage safety.

The invention has the following advantages:

1. Better stable structure: its water inflow is introduced into the tube combination base body through the stationary top ring body to allow the guide disc body disposed inside the tube combination base body to form the floating state. An interval is formed between the guide disc body at the floating state and the inner ring base portion of the tube combination base body to introduce the inflow water into and out of the pilot hole portion of the tube combination base body. When the water pressure of inflow water exceeds in setting values, the force receiving arms of the guide disc body is pressed to closely attach the guide cone portion at the lower side on the edge of the inner ring base portion of the tube combination base body so that the pilot hole portion of the tube combination base body is sheltered by the guide cone portion to achieve a purpose of automatic turning-off. When water pressure reaches the setting value to explode the valve leading to water leakage, the water resource is automatically turned off in no time, preventing the water pipes from exploding due to excessive water pressure or ageing water pipes, thereby having better stable structure.

2. High usage safety: it can avoid tube burst and water leakage through a stationary top ring body, a guide disc body and a tube combination base body. It further prevents risk factors from occurring via the foregoing components, thereby achieving high usage safety.

While the means of specific embodiments according to the present invention has been described by reference drawings, numerous modifications and variations could be made thereto by those skilled in the art without departing from the scope and spirit of the invention set forth in the claims. The modifications and variations should in a range limited by the specification of the present invention.

What is claimed is:

1. An inlet valve explosion-proof structure comprising:
a stationary top ring body, a water inlet portion disposed inside the stationary top ring body, an engagement flange portion disposed at a top side edge of the stationary top ring body;
a guide disc body, a guide cone portion respectively disposed at an upper side and a lower side of the guide disc body, several force receiving arms outwardly extended from a bottom side of the guide cone portion; and
a tube combination base body, an inner ring base portion disposed inside the tube combination base body, a pilot hole portion disposed inside the inner ring base portion, the guide disc body contained in the tube combination base body, the several force receiving arms of the guide disc body leaning against the inner ring base portion, the stationary top ring body and the tube combination base body fit and disposed to each other, the engagement flange portion of the stationary top ring body engaged to a top side of the tube combination base body to form an interval between the several force receiving arms of the guide disc body and a bottom side of the stationary top ring body.

2. The inlet valve explosion-proof structure of claim 1, wherein a propping flange portion is disposed at an external upper place of the tube combination base body, and the engagement flange portion of the stationary top ring body is engaged to the propping flange portion.

3. The inlet valve explosion-proof structure of claim 1, wherein the force receiving arms of the guide disc body is relatively disposed at a cross shape.
